(19) United States
(12) Patent Application Publication
(10) Pub. No.: US 2024/0154498 A1
(43) Pub. Date: May 9, 2024

(54) GENERATOR HOUSING DRAIN

(71) Applicant: Enviro Power, Inc., South Windsor, CT (US)

(72) Inventors: Michael A. Cocuzza, Glastonbury, CT (US); Graham H. Steen, Glastonbury, CT (US)

(21) Appl. No.: 18/550,015

(22) PCT Filed: Mar. 11, 2022
(86) PCT No.: PCT/US2022/071114

§ 371 Date: Sep. 11, 2023

Related U.S. Application Data
(60) Provisional application No. 63/159,654, filed on Mar. 11, 2021.

(51) Int. Cl. H02K 7/18; H02K 5/10; H02K 7/00

(52) U.S. Cl. CPC H02K 7/1823; H02K 5/10; H02K 7/003; H02K 2205/09

(57) ABSTRACT

In a sealed Rankine cycle system including a turbine driven generator, a drain in a housing portion surrounding the generator allows Rankine cycle working fluid that may enter the housing portion to drain away from sensitive components of the generator. The drain includes collection areas in the housing portion located at gravitational low points of the housing so that working fluid does not contact sensitive components of the generator. The drain includes a check valve to prevent working fluid that has flowed out of the housing portion from flowing back into the housing portion. The drain is fluidly connected to a working fluid accumulator of the Rankine cycle system so that working fluid is not lost to the system.

### BACKGROUND

The disclosure relates to generator housing drain. More particularly, the disclosure relates to a generator housing drain for a steam turbine driven generator.

The Rankine cycle is a fundamental operating cycle of power plants where an operating fluid is continuously evaporated and condensed. A closed Rankine cycle system includes a boiler or evaporator for the evaporation of an operating fluid, a turbine (or other expander) fed with the vapor to drive a generator or other load, a condenser for condensing the exhaust vapors from the turbine back to liquid, and a pump for recycling the condensed fluid to the boiler/evaporator. Operating fluids for Rankine cycle systems include water and organic refrigerants such as R-245fa or R134a. Selection of operating fluid depends mainly on the temperature range at which the Rankine cycle system will operate, with organic refrigerants best suited to lower operating temperatures and water/steam being best suited for higher operating temperatures.

Steam is used for a wide variety of processes and is commonly employed as an operating fluid in Rankine cycle systems to convert thermal energy into mechanical work, which can be used to generate electricity. The most common way of generating steam is to combust fuel to release heat, which is transferred to water in a heat exchanger that may be referred to as a boiler or an evaporator. Many steam boilers employ arrangements to recover heat from the exhaust gasses after the gasses have been used to generate steam. Boilers commonly employ housings and insulation to contain the heat from combustion and focus the heat on tubes containing the water. Different arrangements of tubes are employed to enhance heat transfer from the hot combustion gasses to the water.

In systems that employ steam to generate electricity, superheated steam is delivered to an expander such as a steam turbine. As the steam passes through the turbine, it delivers motive force to turn a generator, and leaves the turbine as steam at a lower temperature and pressure. After passing through the expander, steam is cooled and condensed back to liquid water in a heat exchanger dedicated to this purpose called a “condenser.” This liquid water is then pumped back into the boiler or evaporator to complete the cycle. The condenser may be configured to deliver the heat recovered from the turbine exhaust to another system, such as domestic hot water, hydronic heating systems, or an evaporative cooling system such as an absorption chiller. Heat is also commonly recovered from the exhaust gasses leaving the boiler or evaporator.

Small scale or “micro” combined heat and power (CHP) systems designed for installation in the mechanical room of a home or a small business must be extremely compact and release small amounts of heat to the surrounding environment. These systems generate steam and employ a steam turbine to generate electricity, with heat recovered from exhaust gasses and the condenser for use by the home or business owner.

Micro CHP systems provide back-up power generation, low cost electricity, and heat in a single system, making them attractive alternatives to conventional heating systems. Further, micro CHP systems can be connected to communicate with each other and provide coordinated response to peak power demand or load absorption when renewable sources place excess power on the grid. Additionally, sealed micro CHP systems allow the home or business owner to operate these systems with minimal user interaction (as the sealed system is designed to operate as a stand-alone unit).

One of the challenges in sealed micro CHP systems is managing steam leaks and/or moisture while maintaining the sealed nature of the system. Preventing leaks and minimizing moisture in the sealed system promotes extended operation times between service intervals, as steam leaks and/or moisture can damage sensitive system components, can lead to working fluid loss, and can also result in system inefficiencies.

Accordingly, there is a need for minimizing steam leakage and moisture in micro CHP systems, while also allowing for recovery of the working fluid during operation.

There is also a need for a compact and cost effective arrangement of a steam generator, turbine, and drain system suitable for micro CHP systems installed in residential and small business structures.

### BRIEF DESCRIPTION OF THE DRAWINGS

FIG. 1 is cross section side view of a turbine generator and drain lines connected to an accumulator according to aspects of the disclosure;

FIG. 2 is an enlarged cross section side view of the turbine generator and drain lines of FIG. 1;

FIG. 3 is an enlarged sectional view through a check valve suitable for use in the drain line of a disclosed embodiment of a turbine driven generator; and

FIG. 4 is a sectional view through an embodiment of a turbine driven generator assembly connected to a condenser and illustrating representative drains in the generator housing according to aspects of the disclosure.

### DETAILED DESCRIPTION

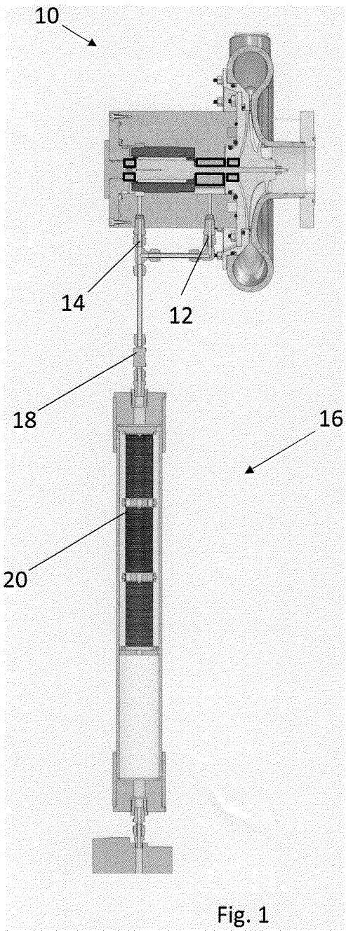

Referring to FIG. 1, a side (cross sectional) view of one embodiment of a steam turbine driven generator 10 with drain lines 12, 14 connected to an accumulator 16 via a valve 18 is shown. The steam turbine driven generator 10 may be part of an enclosed system with a pump that requires a minimum net positive suction head (NPSH) to operate. According to various exemplary embodiments, the enclosed system may not have the benefit of atmospheric pressure and so the system employs the accumulator 16, or reservoir of working fluid to provide a vertical column of fluid that, under force of gravity, provides the required NPSH. In the embodiment shown in FIG. 1, the accumulator 16 may include an integrated filter 20, however in some other embodiments, the filter may not be integrated with the accumulator and the filter could be connected upstream of the accumulator 16. In yet further embodiments, the accumulator may be provided without any type of integrated or connected filter.

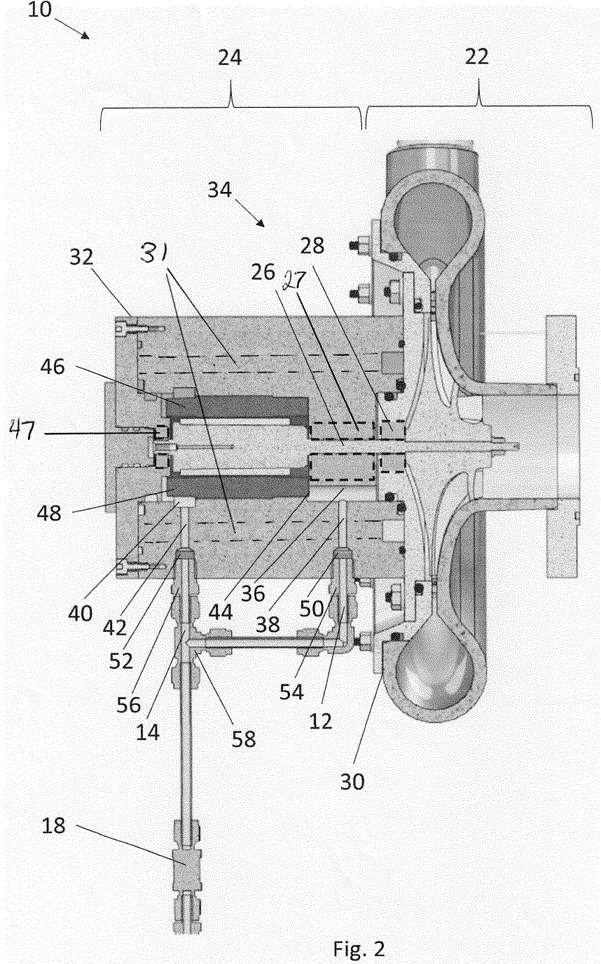

Referring now also to FIG. 2, the steam turbine driven generator 10 comprises a steam turbine section 22, a generator section 24, and a shaft 26 coupling the steam turbine section 22 to the generator section 24. As shown in FIGS. 1 and 2, the steam turbine driven generator 10 is provided with drains 12, 14 to remove moisture that may get past seals 28 on the shaft 26 that extends from the turbine to the generator. The shaft 26 rotates within the seals 28, which are subject to wear. Even with new seals 28, it can be nearly impossible to prevent all leakage of steam past seals 28 on the shaft 26. Water condensate can cause substantial damage to the generator. In some embodiments, the generator section housing 32 may include coolant passages 31 to circulate coolant to keep the generator below a pre-determined maximum operating temperature. Although the coolant passages 31 are sealed, coolant leaking from coolant passages is another potential source of moisture entering the generator. The shaft 26 is supported by bearings 27 and 47 that may be damaged by moisture. In addition, the generator may include coils, conductors or other components that can be corroded if moisture is allowed to accumulate within the generator. Damage to the bearings 27, 47 or other components of the generator can result in premature failure of the generator. Since leakage at least from the shaft seal 28 will be present, it is necessary to manage the resulting moisture in the generator to prevent it from accumulating and causing damage.

The turbine section 22 and the generator section 24 are assembled as a sealed unit where a turbine section housing 30 and a generator section housing 32 are provided with overlapping surfaces including seals and connected to each other (such as by fasteners, for example) to form a sealed turbine generator housing 34 as shown in FIG. 2. The turbine and associated fluid pathways for the working fluid (water or refrigerant) are evacuated so the only fluids present in the fluid pathways are liquid and gaseous working fluid (water, steam, water vapor, or refrigerant). When the system is not operating, the turbine generator housing 34 is at a low temperature and pressure in the fluid passages is low. As steam is circulated through the turbine, heat is absorbed by the metal components of the turbine generator housing 34 and connected turbine and generator and pressure inside the sealed turbine generator housing 34 increases. This temperature and pressure cycling can also drive fluids past seals and result in leakage.

According to various exemplary embodiments, the generator housing section 32 is provided with at least one drain collection area 36, 40 at a gravitational low point of the generator housing section 32. Arranging the drain collection areas 36, 40 at a gravitational low point of the generator housing allows any water, steam, and/or water vapor that leaks past the shaft seals 28 to accumulate as it moves under the influence of gravity. The moisture is allowed to drain to drain lines 12, 14 in a manner that does not allow outside air to enter the sealed turbine generator housing 34. As shown in the cross section view of FIG. 2, the generator section 24 comprises a first drain collection area 36 connected to a first passage 38, and a second drain collection area 40 connected to a second passage 42. The first drain collection area 36 and the second drain collection 40 area are at an inner central portion of the generator section 24. The first drain collection area 36 is between an interface between the turbine section 22 and the generator section 24 and a first end 44 of a stator portion 46 of the generator section 24. The second drain collection area 40 is proximate a second opposite end 48 of the stator portion 46. The first passage 38 extends from the first drain collection area 36, through the generator section housing 32, and to a first drain line connection opening 50. The second passage 42 extends from the second drain collection area 40, through the generator section housing 32, and to a second drain line connection opening 52. The drain line connection openings are provided at low points of the generator housing to allow condensate to leave the generator housing by force of gravity, but also influenced by increased pressure within the sealed enclosure when the system is at an operating temperature, e.g., hot. The drain collection areas 36, 40 are arranged to keep accumulated moisture away from sensitive components of the generator such as bearings 27, 47 and the stator and rotor of the generator.

According to various exemplary embodiments, the first and second passages 38, 40 may be substantially parallel to each other and extend in radial directions (relative to a centerline of the shaft 26). However, in other embodiments any suitable configuration or orientation for the passages may be provided. The first and second drain line openings 50, 52 are configured to receive drain line fittings 54, 56 for connection to the first and second drain lines 12, 14.

The turbine generator housing 34 forms part of the sealed, evacuated system associated with the working fluid, turbine and associated components such as an evaporator (to generate energetic, gaseous phase working fluid), a condenser (to remove heat from gaseous phase working fluid after it has been used to turn the turbine/generator) and associated fluid pathways. It is important to note that while the generator housing section 32 is connected to the turbine housing section 30 as part of the sealed turbine generator housing 34, it is not intended that working fluid pass into the generator housing section 32. Seals 28 on the shaft 26 permit only a small amount of working fluid into the generator housing section 32 and the disclosed generator drain is configured to capture this working fluid and remove it from the generator housing section 32 while maintaining the overall integrity of the sealed Rankine cycle system.

In order for the system to remain sealed, the drain system is configured such that fluid can leave the turbine generator housing 34, but the fluid/vapor cannot go back into the turbine generator housing 34. As shown in FIGS. 1 and 2, the valve 18 (which is embodied as a check valve) is provided to allow for drainage in a manner that does not allow outside air to enter the sealed enclosure. In the embodiment of FIGS. 1 and 2, the check valve 18 is installed downstream of where the drains 12, 14 are connected to each other (such as at a tee connection fitting 58). The valve member of the check valve 18 is lightly biased toward a closed position so that the weight of a small amount of water (or condensed working fluid) will open the check valve and allow the water to flow out but will close again immediately to prevent moisture or working fluid from re-entering the generator housing section 32.

According to various exemplary embodiments, the check valve 18 allows condensed, liquid phase working fluid to leave the generator housing 34 without opening the sealed enclosure encompassing all the working fluid passages of the Rankine cycle system. More specifically, the check valve 18 is configured to allow condensed working fluid to drain from the generator housing section 32 without breaking the sealed, evacuated system in which the working fluid circulates. The check valve 18 allows for the condensed working fluid drained from the generator housing to be returned to the accumulator for re-use within the closed system. Additionally, the normally closed check valve 18 stays closed during system downtime to prevent the re-introduction of working fluid or vapor phase working fluid into the generator section housing 32 due to low pressure that may be present in the generator housing section 32 when the system is cold.

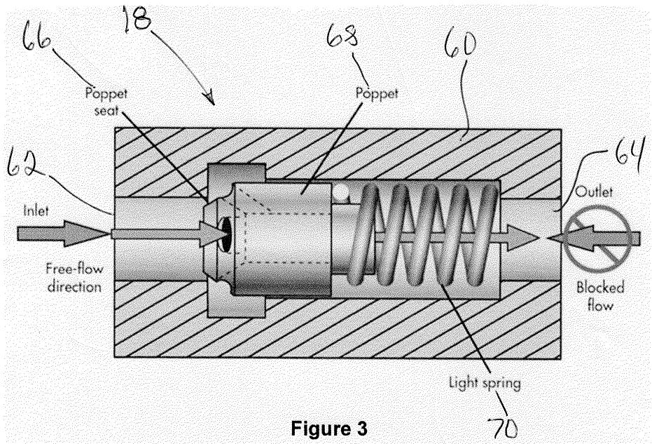

FIG. 3 illustrates an exemplary check valve 18 compatible with the disclosed generator drain. The body 60 of the check valve 18 defines an inlet 62 and outlet 64 opening that are provided with threaded or other sealed coupling to connect the check valve 18 to the drain lines 12, 14. Sealed connections in a closed system can be accomplished using reversible connections such as threaded connections or permanent connections such as brazed, soldered, or crimped connections, all of which are compatible with the disclosed generator drain. The body 60 of the check valve 18 defines a valve seat 66 against which the valve member 68 is lightly biased by a bias member 70 such as a coil spring. The bias provided by the bias member 70 is sufficient to hold the valve member 68 in the closed position when little or no condensed working fluid is present in the drain lines 12, 14 above the check valve 18, but is light enough to open to allow condensed working fluid to pass through the check valve 18. The check valve 18 of FIG. 3 is a poppet type valve with a reciprocating poppet valve member 68. Other valve member types such as a ball or plate may also be compatible with the disclosed generator drain.

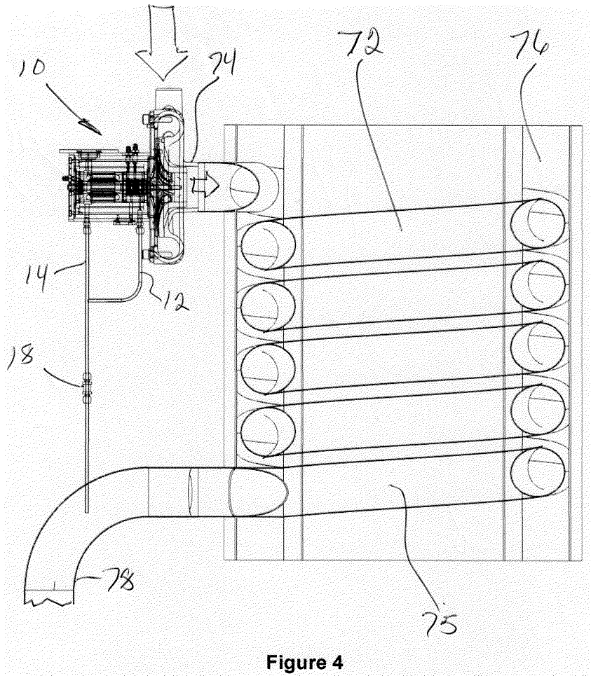

FIG. 4 shows an embodiment of the disclosed generator drain in a Rankine cycle system partially illustrated to show an exemplary condenser 72 attached to the turbine outlet 74. The condenser 72 takes the form of a helical tube 75 arranged in a cylindrical space 76 and surrounded by coolant. Turbine exhaust enters the condenser 72 at an upper end and moves down the helical tube 75 where vapor phase working fluid is condensed on the cooled walls of the helical tube 75. Condensed working fluid flows down the helical tube 75 and is collected in an accumulator 78 outside the cylindrical space 76 and not in contact with the coolant. The accumulator 78 is fluidly connected to a pump (not shown) that circulates the liquid phase working fluid back to a boiler or evaporator (not shown) where it is heated to form energetic vapor-phase working fluid that is recirculated to the inlet of the turbine. The disclosed generator drain is not limited to use with this form of condenser and is compatible with all closed Rankine cycle configurations and working fluids. In the disclosed condenser 72, the accumulator 78 is an extension of the helical tube 75 that projects downwardly and allows condensed working fluid to collect. The volume of working fluid in the sealed system and the configuration of the accumulator 78 are selected to ensure sufficient NPSH at the pump which circulates liquid phase working fluid to the boiler or evaporator.

The outlet of the check valve 18 is connected in a sealed manner to the accumulator 78 so that condensed working fluid removed from the generator housing section 32 is combined with other condensed working fluid and is not lost to the system. Management of the working fluid within the sealed system prevents loss of working fluid and reduces the need for maintenance of the sealed Rankine cycle system, while preventing working fluid from accumulating in the generator housing section. Although the exemplary embodiments show more than one drain opening in the generator housing section 32 connected to a single check valve 18, each drain opening may be provided with its own check valve 18.

While various exemplary embodiments have been described above in connection with a check valve where water pushes open the check valve when draining is needed, other embodiments may comprise an active valve that detects a water level and actuates the valve. However, any suitable configurations having active and/or passive valves may be provided.

Technical effects of any one or more of the exemplary embodiments provides a vented generator connection from the generator housing to the accumulator, with a check valve therebetween so that fluid can leave, but fluid/vapor cannot go back into the housing. The various exemplary embodiments provide significant improvements over conventional configurations by providing drains in the generator housing connected to the turbine, where the generator shares a sealed housing with the turbine in a sealed, evacuated Rankine cycle system. Additional technical effects of any one or more of the exemplary embodiments provide a generator housing including at least one drain having a check valve to control drainage of condensed working fluid from the generator housing.

It should be understood that components of the various exemplary embodiments can be operationally coupled or connected and that any number or combination of intervening elements can exist (including no intervening elements). The connections can be direct or indirect and additionally there can merely be a functional relationship between components.

It should be understood that the foregoing description is only illustrative of the various exemplary embodiments. Various alternatives and modifications can be devised by those skilled in the art without departing from the various exemplary embodiments. Accordingly, the various exemplary embodiments are intended to embrace all such alternatives, modifications and variances.

1. A turbine driven generator comprising:
a turbine;
a generator connected to be driven by the turbine; and
a turbine generator housing surrounding the turbine and the generator, wherein the turbine generator housing comprises a first portion and second portion, wherein the first portion and the second portion are coupled and sealed together, wherein the first portion surrounds the turbine, wherein the second portion surrounds the generator, and wherein the second portion is provided with at least one drain configured to allow for drainage of condensed working fluid from the housing second portion.

2. The turbine driven generator of claim 1 further comprising a check valve connected to the at least one drain, wherein the check valve is configured to open to allow drainage of accumulated condensed working fluid from the housing second portion and close after the condensed working fluid has drained from the housing second section to prevent condensed working fluid or working fluid vapor from flowing back into the housing second portion.

3. The turbine driven generator of claim 1, wherein the housing second portion defines at least one collection area in fluid communication with the at least one drain, the at least one collection area arranged at a gravitational low point of the housing second portion and arranged so that condensed working fluid in the collection area is kept away from components of the generator that might be damaged by contact with the condensed working fluid.

4. The turbine driven generator of claim 3, wherein the generator is coupled to the turbine by a shaft that extends through a seal arranged to prevent working fluid from passing from the first housing portion into the housing second portion and the at least one collection area is located between the turbine and the generator to collect any working fluid that leaks past the seal.

5. The turbine driven generator of claim 4, wherein the shaft is supported by bearings in the housing second portion and the at least one collection area is arranged to prevent working fluid in the at least one collection area from coming in contact with the bearings.

6. The turbine driven generator of claim 4, wherein the generator includes a stator and a rotor and the at least one collection area is arranged to prevent working fluid in the at least one collection area from coming into contact with the rotor or stator.

7. The turbine driven generator of claim 1, wherein an outlet of the turbine is connected to an inlet of a condenser and vapor phase working fluid leaving the turbine outlet is condensed in the condenser to liquid phase working fluid that collects in an accumulator, the drain is connected to the accumulator in a sealed manner so that condensed working fluid from the housing second portion is combined with condensed working fluid in the accumulator within a sealed Rankine cycle system and without loss of working fluid.

8. The turbine driven generator of claim 2, wherein the check valve includes a valve member biased toward a closed position by a bias member, said bias member selected to allow condensed working fluid to flow out of the housing second portion by gravity.
